(19) United States
(12) Patent Application Publication
(10) Pub. No.: US 2021/0227848 A1
(43) Pub. Date: Jul. 29, 2021

(54) CAPSULE-BASED FOOD PRODUCT BLENDING AND ASSOCIATED METHODS

(71) Applicant: ADVANTIR INNOVATIONS PTE LTD., Singapore (SG)

(72) Inventors: Jeremy Tan Peng Yang, Singapore (SG); Narendhar Mohanasundram, Singapore (SG)

(73) Assignee: ADVANTIR INNOVATIONS PTE LTD., Singapore (SG)

(21) Appl. No.: 17/227,299

(22) Filed: Apr. 10, 2021

Related U.S. Application Data
(62) Division of application No. 16/533,784, filed on Aug. 7, 2019.

(30) Foreign Application Priority Data
Sep. 13, 2018 (SG) PCT/SG2018/050469

(51) Int. Cl. A23G 9/12; A23G 9/22; A23G 9/28; B65D 85/804

(52) U.S. Cl. CPC A23G 9/12; B65D 85/804; A23G 9/28; A23G 9/224

(57) ABSTRACT

A sealed capsule for blending and dispensing an initially solid food product holds a blending component with embedded food product. Actuating the blending component through an electronic control system causes the food product to be blended within the capsule. One or more feedback control mechanisms are used to guarantee a desired consistency of the blended food product. Provided are structural features of the capsule, and methods of using its contents to blend and dispense soft-serve products.

### CLAIM OF PRIORITY

The present application claims priority to PCT Application Ser. No. PCT/SG2018/050469 filed Sep. 13, 2018 designating the Intellectual Property Office of Singapore (IPOS) as the receiving office. Said PCT Application subsequently claims priority to U.S. Provisional Patent Application Ser. No. 62/599,732, filed Dec. 17, 2017. The entire disclosures of the above applications are hereby expressly incorporated by reference herein.

### FIELD OF TECHNOLOGY

This disclosure relates generally to capsules for food products and, more particularly, to a method, a device and/or a system for serving a blended food product, such as frozen food products and/or beverages, through a capsule in a blending machine.

### BACKGROUND

Blending machines are well known in the art for mixing and transforming a hard, frozen food product such as ice cream to a substantially soft, smooth, and creamy product fit to serve.

A commonly available over-the-counter machine for blending such frozen food products utilizes an auger that extends into a generally funnel-shaped mixing container. A frozen food product such as ice cream and/or other ingredients (such as fruit) are placed in the container and subsequently blended by the auger component of the machine. The mixing container typically allows the blended product to be dispensed through a bottom opening thereof. However, such machines are cumbersome to use and require routine cleaning to comply with food safety guidelines. Additionally, machine operators must prepare any additional ingredients previous to blending, such as peeling and cutting fruit, which is time consuming and requires space and labor. An example of such a machine can be seen in U.S. Pat. Pub. No. 20080219090 to Duane H Heinhold.

Furthermore, various devices have been developed for the purpose of blending and dispensing a soft-serve form of frozen food products. One example of a conical screw blender is U.S. Pat. Pub. No. 20080094934 to Win-Chin Chiang that discloses about a conical screw blender that can be used for mixing as well as for drying of food materials. The conical screw blender includes an inverted cone-shaped vessel, a material inlet, a material outlet, a driven screw housed within the vessel, and at least two non-diffused gas injection lines attached to the vessel.

U.S. Pat. No. 6,071,006 to Hochstein et al that discloses about a novel container equipped with an integral stirring mechanism. The container is used for a pre-packaged food product, such as a frozen beverage. According to the patent, the stirrer is fixedly configured as a part of the container structure.

U.S. Pat. Pub. No. 20070291583 to Robert Joseph Baschnagel discloses a drink blender system with a single use lid permitting a user to dispose of the lid and integrated mixing components present therein after use.

A capsule for beverage ingredients may be seen in U.S. Pat. No. 9,072,402 to Antoine Ryser. According to the document, the capsule is designed for insertion in a beverage production device. The capsule comprises a cup-like body portion, a flange-like rim portion, a delivery wall and a sealing member having—in a radial cross-sectional view—at least one concentric protrusion and/or recession.

A capsule for mixing a viscous beverage is described in U.S. Pat. Pub. No. 20160214787. The capsule utilizes pressure created by an internal mixing unit to deposit the mixed beverage. Increased pressure is not ideal for achieving a desired consistency for certain frozen food products, such as ice cream, which should contain a certain amount ‘overrun’ or mixed air to be considered superior quality for serving.

Current solutions with auger components also run the risk of wearing away the blade as its edges are forced against surfaces, causing particles to inadvertently enter the food product. Additionally, current feedback solutions for blending control fail to gauge the consistency of the food product while blending without directly contacting the food product.

Although solutions exist in the art for blending as well as dispensing a soft-serve form of food products, there still exists a significant need in the art for an improved blending and dispensing system that facilitates speedy blending and dispensing of frozen food products without requiring excessive maintenance or compromising food safety while guaranteeing the consistency of dispensed food product.

### SUMMARY

Aspects of the invention relate in part to the use of capsules storing food product and configured to blend and dispense the same in an efficient, hygienic manner Blending the food product operates based on a feedback system involving physical characteristics of the capsule and an electronic control system which actuates the contents of the capsule.

In one aspect, a capsule for blending and dispensing food product stored therein comprises a receptacle with a top opening and a bottom opening. The bottom opening is hermetically sealed by a seal to form a receiving chamber surrounded by a wall of the receptacle. The receiving chamber is adapted to receive and store a food product. The food product is sealed on top by a lid removably covering the top opening. The lid comprises a central opening centrically aligned with the top opening.

In the same aspect, the capsule also contains a blending component within the receptacle and embedded with the food product. The blending component has a top end accessible through the central opening of the lid and an auger-like blade. The top end features a profiled depression which is actuated by a driveshaft of an electronic control system. The driveshaft extends through the central opening of the lid to access the profiled depression. As such the blending component closely conforms to the profile of the receptacle wall. The receptacle and the blending component taper around the bottom opening.

The auger-like blade comprises a first surface and a second surface joined by an edge which extends laterally from a central axis of the blending component to the wall of the receptacle. The blade helically spans around the central axis from the top end to a tip portion of the blending component. Rotating the auger-like blade causes at least one of the first surface and the second surface to move the food product around and along the central axis.

As the blending component is actuated by the electronic control system, the auger-like blade rotates and at least one of the first surface and second surface urges the food product to eddy within the receptacle until a desired consistency of the food product is reached. Subsequent to reaching the desired consistency and removal of the removable seal, the food product is dispensed through the bottom opening.

The auger-like blade may sit flush against the wall of the receptacle with a threshold tolerance of no less than 3 microns. This prevents wear of the auger-like blade and deposit of trace contaminants in the food product while ensuring an adequate seal between the edge and the wall. In addition, the top end of the blending component may comprise a surface which sits flush against the bottom surface of the lid. This seal causes the food product within the receiving chamber to be bound by the lid, the central axis, the first surface, the second surface, and the wall of the receptacle when it is moved by rotation of the blending component.

The auger-like blade may be split into a plurality of steps. Between each step, the first surface and second surface may comprise a concave portion. The concave portion may serve to scoop the food product in the direction the blending component is being rotated. The steps may also facilitate ejection of the blending component from manufacturing molds and impart rigidity to the auger-like blade.

A rotational torque applied to the blending component by the driveshaft may be approximately 5 to 15 Nm. This may aid in breaking up initially frozen food product. Additionally, in another aspect, the blending component may be rotated at a threshold RPM necessary to generate a minimum centrifugal force to push the food product away from the central axis. In yet another aspect, the desired consistency can be arrived by determining whether a target current is being drawn by the electronic control system. The target current may be encoded on a product label positioned on the exterior of the receptacle and readable by the electronic control system.

In another aspect, a method of blending and dispensing a food product from a capsule involves actuating a blending component disposed within a receiving chamber of a receptacle of the capsule. The receptacle features a top opening and a bottom opening and is covered by a lid having a central opening. The bottom opening is hermetically sealed by a removable seal. The receiving chamber is surrounded by a wall of the receptacle. The receiving chamber is adapted to receive and store a food product. The blending component is embeddable with the food product and comprises a top end which incorporates an aperture accessible through the central opening of the lid.

Actuating the blending component involves blending the food product to a soft serve consistency. To achieve this, the blending component comprises an auger-like blade having a first surface and a second surface joined by an edge which extends laterally from a central axis of the blending component to sit flush against the wall of the receptacle. The auger-like blade helically spans from the top end to a tip portion around the central axis.

The auger-like blade is split into a plurality of steps by one or more concave portion(s) disposed between each of the steps. Blending involves rotating the blending component via the driveshaft and thereby applying a rotational torque to the food product. This causes one of the first surface, the second surface, and the concave portion(s) to move the food product around and along the central axis. The concave portion(s) may scoop the food product in the direction the blending component is rotated. Rotating the blending component further causes the helical auger-like blade to move the food product outward from the central axis and urge the food product to eddy against the wall of the receptacle.

Actuating the blending component finally involves dispensing the food product through the bottom opening subsequent to removal of the removable seal. First, however, dispensing may additionally involve prompting to remove the removable seal from the bottom opening of the receptacle. Alternately, dispensing may additionally involve mechanically removing the removable seal from the bottom opening of the receptacle via the electronic control system.

Ending the step of blending the food product may additionally involve detecting whether a threshold value has been met by the electronic control system. For example, the threshold value may be an RPM value and may be approximately 1000 to 1500 RPM. Alternately or in addition, the threshold value may be a rotational torque applied to the food product and may be approximately 5 to 15 Nm. Alternately or in addition, the threshold value may be a current drawn by the electronic control system which is closely associated with the desired consistency.

### BRIEF DESCRIPTION OF THE DRAWINGS

The embodiments of this invention are illustrated by way of example and not limitation in the figures of the accompanying drawings, in which like references indicate similar elements and in which:

FIG. 1 illustrates a capsule having a blending component rotatably disposed within a receptacle for blending and dispensing a soft serve form of food products and/or beverages disposed within the capsule, in accordance with an exemplary embodiment of the present invention.

FIG. 2 is an exploded view of the capsule of FIG. 1 showing receptacle, blending component, and a lid, in accordance with an exemplary embodiment of the present invention.

FIG. 3 is another exploded view of the capsule shown in FIG. 1, in accordance with an exemplary embodiment of the present invention.

FIG. 4 is a cross-section view of the capsule of FIG. 1 showing a hollow central shaft which allows the blending component suspended in a food product to be actuated by a driveshaft of an electronic control system through the lid of the capsule, in accordance with an exemplary embodiment of the present invention.

FIG. 5 is a block diagram of an electronic control system configured to actuate the blending component of FIG. 1, in accordance with an exemplary embodiment of the present invention.

FIG. 6 is a process flowchart describing an exemplary method for blending and dispensing a frozen food product stored in a capsule as shown in FIG. 1.

FIG. 7 illustrates forces acting on the capsule during operation of the electronic control system.

FIG. 8 is a process flowchart describing an exemplary method for blending and dispensing a frozen food product stored in a capsule as shown in FIG. 1.

FIG. 9A is a perspective view of a stepped embodiment of the blending component.

FIG. 9B is a left plan view of the stepped blending component of FIG. 9A.

FIG. 9C is a right plan view of the stepped blending component of FIG. 9A

FIG. 9D is a front plan view of the stepped blending component of FIG. 9A.

FIG. 9E is a rear plan view of the stepped blending component of FIG. 9A.

FIG. 9F is a top plan view of the stepped blending component of FIG. 9A.

FIG. 9G is a bottom plan view of the stepped blending component of FIG. 9A.

FIG. 10 depicts a sealed receptacle, according to one or more embodiments.

Other features of the present embodiments will be apparent from the accompanying drawings and from the detailed description that follows.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Elements described herein as coupled may have a direct or indirect connection with one or more other intervening elements.

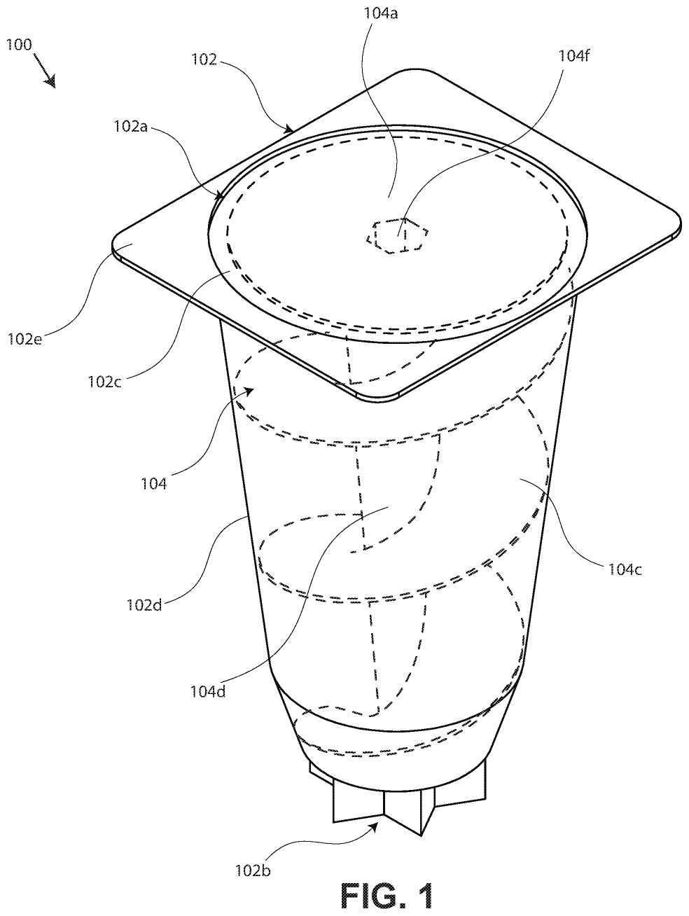

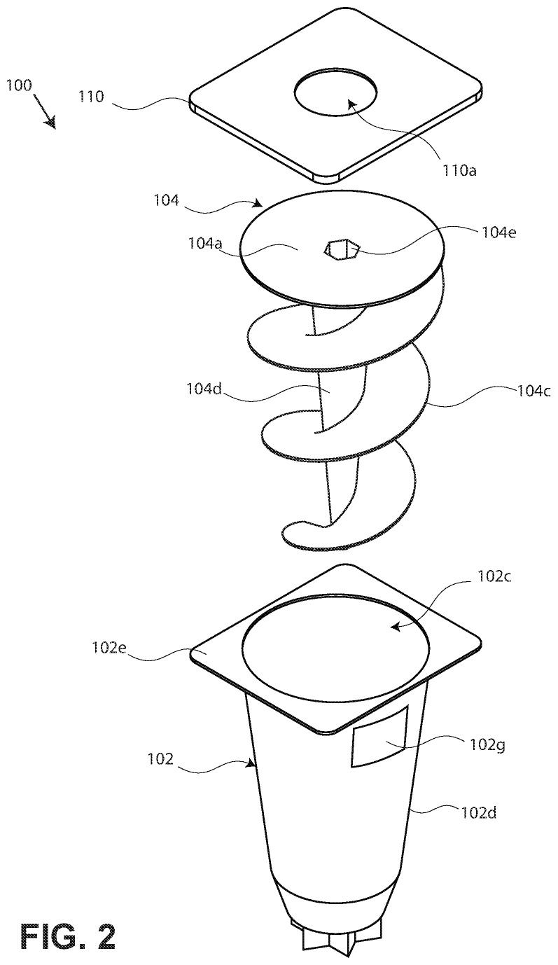

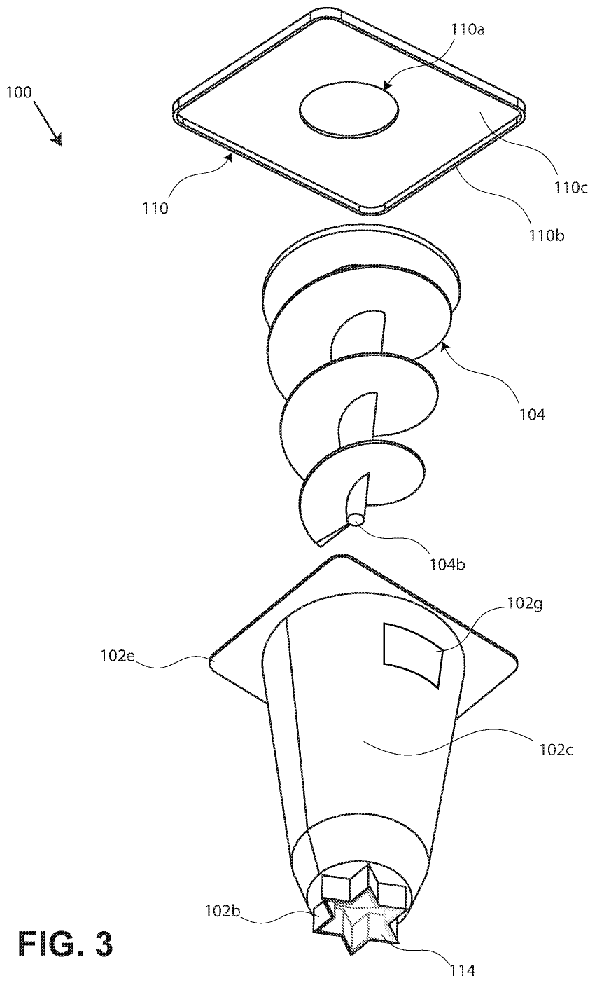

Referring to FIGS. 1-3, a capsule 100 is shown to comprise a receptacle 102 which includes a top opening 102a and a bottom opening 102b. The bottom opening 102b is hermetically sealable, for example, by using a seal 114 to form a receiving chamber 102c surrounded by a wall 102d of the receptacle 102. The receiving chamber 102c is configured to receive and store food products, particularly frozen food products, therein as a result of a manufacturing process. The food product may include beverages, suspended solids, or any other food product that may benefit from blending prior to dispensing.

The seal 114 may aid in preventing leakage of food product outside the capsule 100 when the capsule is filled with the food product, i.e., through the top opening 102a and/or the bottom opening 102b. The bottom seal 114 prevents contaminants from entering the receptacle and may be removed by, for example, removing a packaging (not shown) which may adhere to the bottom seal 114 and, when removed, may also remove the bottom seal 114 to expose the bottom opening 102b. The shape of the receptacle in the illustrated embodiments may be substantially conical shape, the narrower end of which terminates at the bottom opening 102b. The bottom opening 102b may be an aperture having walls shaped for optimum dispensing of soft-serve frozen product. However, it should be understood that the scope of the present disclosure is not limited to the shape of the receptacle 102 or the bottom opening 102b.

The capsule 100 further comprises a lid 110 removably covering the top opening 102a of the receptacle 102. The lid 110 may comprise sidewalls 110b configured to fit onto a flange 102e of the receptacle 102. The flange 102e may be shaped in such a way to facilitate holding the receptacle 102 in place, especially while internal components are rotated by an external drive mechanism. In one embodiment, the flange 102e may be rectangularly-shaped. In another embodiment, the flange 102e may comprise one or more fins (not shown) protruding from above and/or beneath the flange 102e and which may act as hooks and may facilitate holding the receptacle 102 in place and/or preventing it from rotating. For example, the flange 102e may fit into a holding chamber which may receive the flange 102e within one or more recesses of the holding chamber and keep the receptacle 102 in place and/or prevent it from rotating.

The lid 110 comprises a central opening 110a which may preferably be, but not limited to, circular in shape. According to an embodiment, an additional seal (not shown) may be temporarily applied over the central opening 110a during packing to prevent accidental leakage of the stored food product from the capsule 100 prior to deploying the capsule 100 to be engaged with an electronic control system. Keeping the central opening 110a sealed prevents contaminants from entering the capsule 100 and prevents the contents of the capsule 100 from potentially leaking out of the capsule 100.

The capsule 100 further comprises a blending component 104 mounted within the receiving chamber 102c of the receptacle 102. The blending component 104 is deposited into the receiving chamber 102c with a tip portion 104b pointing into the receiving chamber 102c. When properly disposed within the receiving chamber 102c, the blending component 104 sits within the capsule 100 such that a top end 104a of the blending component 104 sits flush with the flange 102e of the receptacle 102. As such, a bottom surface 110c of the lid 110 sits on both the flange 102e of the receptacle 102 and the top end 104a of the blending component 104.

The blending component 104 may be embedded with the food product stored inside the receiving chamber 102c, i.e., the blending component 104 may freely suspend within the receiving chamber 102c and be surrounded by the food product (e.g., frozen ice cream).

According to another embodiment, the blending component 104 may be fixedly or removably mounted within the receiving chamber 102c of the receptacle 102 with its top end 104a fixedly or removably attached to the lid 110.

In one embodiment, the blending component 104 is an auger-like component as best shown in the figures. “Auger” or “auger-like” as used herein are meant to refer to any component incorporating a screw-shaped surface. In one embodiment, “auger” or “auger-like” may refer to a conically or cylindrically-profiled component having at least one continuous wide surface (e.g., blade 104c) spanning helically around a central axis (e.g., shaft 104d) between a top end (e.g., top end 104a) and a tip portion (e.g., tip portion 104b). However, “auger” or “auger-like” is not meant to be limited to the illustrated embodiments and the above features. For example, “auger” or “auger-like” as used herein may alternately refer to a helicoidally-shaped component.

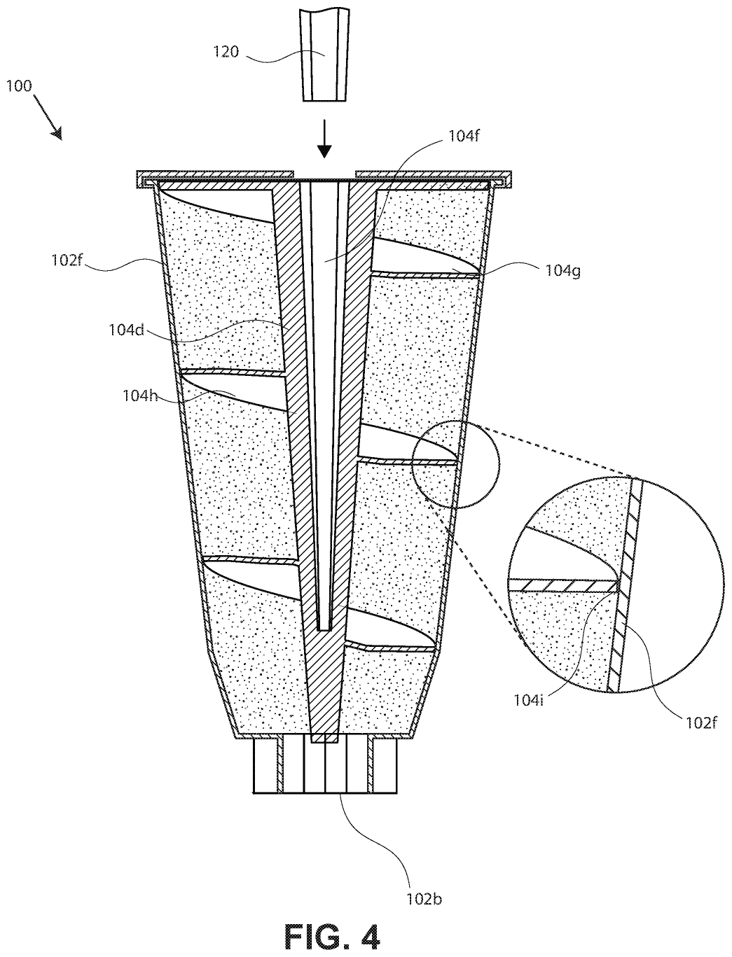

According to a preferred embodiment, the blending component 104 is an auger-like component as shown in FIGS. 1-4. The auger-like blending component 104 comprises a top end 104a, a tip portion 104b, a blade 104c, and a central shaft 104d. The top end 104a may be configured to engage with a drive shaft of a commercially available or specifically design electronic control system.

In one embodiment, the top end 104a comprises an aperture 104e leading to a hollow interior 104f of the driveshaft 104d. A driveshaft 120 of an electronic control system (not shown) may be inserted through the aperture 104e and through at least a portion of the hollow interior 104f of the central shaft 104d. Furthermore, the driveshaft 120 and the hollow interior 104f may be any form factor. For example, as shown, the driveshaft 120 has a hexagonal profile. However, different driveshaft 120 form factors may be used, such as a star or a slot shape.

The hollow interior 104f may be sized to fit at least the length of the driveshaft 120. Alternately, the hollow interior 104f may gradually taper to a point, taper to a flat surface, or comprise internal protrusions which the driveshaft 120 may engage with to more effectively rotate the blending component 104. Generally, the hollow interior 104f is a profiled depression. The hollow interior 104f plays a functional role since the profile of the hollow interior 104f is shaped such that a correspondingly-shaped driveshaft (e.g., driveshaft 120) may engage and rotate the blending component 104 within the capsule 100. The hollow interior 104f also reduces the overall material cost of the blending component 104 and adapts the blending component 104 for manufacturing by, for example, an injection mold since the hollow interior 104f facilitates removal from the injection mold.

In a preferred embodiment, the central shaft 104d is substantially conically shaped. In another embodiment, the central shaft 104d is substantially cylindrically shaped. The blade 104c may span around the central shaft and toward the tip portion 104b and the tip portion 104b may terminate to a flat surface (as shown). The diameter of the flat surface may be less than the diameter of the bottom opening 102b and may be adjusted to alter the flow of the food product 103 leaving the capsule 100.

In a preferred embodiment, the blade 104c comprises a top surface 104g and a bottom surface 104h. The top surface 104g and the bottom surface 104h protrude from the central shaft 104d and couple at the outer edge 104i, which extends laterally from the central axis and rests substantially flush against the wall 102f of the receiving chamber 102c. The blending component 104 may closely conform to the profile of the receptacle 102 but not make full contact to prevent production of particulate matter generated due to friction between the outer edge 104i and the wall of the receptacle 102. This near-contact allows the blending component 104 to contain a flow of a food product 103. To ensure that the flow of the food product 103 is not hindered or constrained, a gap between the threads of the blade 104c may be a minimum distance. For example, the minimum tolerance between the outer edge 104i and the wall of the receptacle 102 may be at least 3 microns.

The blending component 104 as shown is only one example of the structural shape of an auger-like blending component. The blending component 104 may be a mirror image of what is shown or may be a different auger-like shape entirely.

In one embodiment, in a blending mode of the capsule 100, the blending component 104 is rotated in a particular direction (e.g., counter-clockwise) by the action of the driveshaft 120. This blends a food product 103 by causing the top surface 104g to push the food product 103 upwards against the lid 110. As the food product 103 travels is pushed against the lid 110, the food product 103 eddies near the top of the capsule 100, circling back into the flow of food product 103. Meanwhile, the lid 110 stays flush with the top end 104a of the blending component 104, preventing any food product 103 from exiting the capsule 100.

The rotational direction described above, which causes the top surface to urge the food product 103 toward the lid 110, may be preferred for frozen food products. In another embodiment geared for beverages, the blending mode may instead involve rotating the blending component 104 in the other direction, causing the food product 103 to eddy near the sealed bottom opening 102b. Once the food product 103 is blended, the seal 114 may be broken to allow the blending component 104 to continue rotating in the same direction to dispense the product.

As the outer edge 104i slides against the wall 102f of the receptacle 102, production of particulate matter due to friction may be reduced by ensuring the outer edge 104i sits precisely flush against the wall 102f to prevent excess friction. During operation, as the food product 103 (typically a frozen food product) melts, the melted food product effectively lubricates the outer edge 104i, thus reducing friction further. Furthermore, the driveshaft 120 ideally does not apply a downward force on the blending component 104, which is a conically-shaped embodiment. As such, the outer edge 104i of the blade 104c is not excessively urged against the wall 102f.

In a second operational mode of the capsule 100, the blending component 104 is rotated clockwise by the action of the driveshaft 120 and dispenses the food product 103 by causing the bottom surface 104h to push the food product 103 down and dispense the same through the bottom opening 102b.

Contact friction between the outer edge 104i and the wall 102f is transformed into heat during rotation. This heat may be conducted by the receiving chamber 102, the blending component 104 and the lid 110 and gradually warms the food product 103 (typically frozen) as it is blended and translated lid-ward by the motion of the blade 104c. The food product 103 is blended in this way until a desired consistency is achieved. The desired consistency of a food product may depend on the constituents of the food product, the particular taste of the user, a manufacturer recommendation.

In another embodiment, the operational modes may involve rotating the blending component 104 in the same direction, i.e., downward toward the tip portion 104b. During a first operational mode, the food product 103 may be blended while the bottom opening 102b stays sealed by the removable seal 114. Blending in this way, as opposed to blending toward the lid 110, prevents food product 103 from escaping between the flange 104e and the bottom surface 110c and through the central opening 110a of the lid 110.

In a subsequent second operational mode, the bottom opening 102b may be unsealed and the blending component 104 may be rotated in the same direction (i.e., toward the tip portion 104b). This has the effect of urging the food product 103 through the bottom opening 102b of the receptacle 102.

In a preferred embodiment, the blending component 104 rotates until the food product 103 reaches a desired consistency. When the blending mode begins, a torque applied on the driveshaft 120 may be highest and the RPM of the driveshaft 120 may be lowest due to resistance by the frozen or near-frozen consistency of the food product 103. As friction melts the frozen food product 103, the load on the driveshaft decreases and the RPM of the driveshaft rises.

Intuitively, temperature may be used to determine consistency, but temperature readings may only provide insight into measurements taken around the temperature sensor. The temperature of the food product close to the external wall of the capsule may be a different temperature than that of food product close to the central shaft. Although this issue can be remedied by utilizing a plurality of sensors to create a heat map, this may not be as practical as using the driveshaft's actual RPM, driveshaft rotational torque, and/or driveshaft motor current usage and comparing it to a threshold value closely associated with a desired consistency.

As the blade 104c whips through the food product 103, the overall consistency will loosen and actual RPM will increase. The actual RPM can be subsequently compared against a target RPM to reliably measure consistency. For example, a preferred target RPM of the driveshaft 120 may be at least 1000 RPM. However, the target RPM may change based on the form factor of the components of the capsule 100, the specifications of the actuator 156, the initial consistency of the food product 103, the constituents of the food product 103, food product 103 manufacturer specifications, the dimensions of the capsule and components therein, and other factors.

In a further embodiment, the desired consistency of the food product 103 may be facilitated by one or more heating elements in proximity and/or in contact with any constituent of the capsule 100. For example, the driveshaft 120 may be coupled to a heat source. Accordingly, the heated driveshaft 120 may transfer heat as an intrinsic heating element when coupled to the hollow interior 104f of the blending component 104. Thus, heat may be subsequently transferred to the food product 103 via the body of the blending component 104. In another example, a cavity for accommodating the capsule 100 during the above-mentioned operational modes may also transfer heat to the capsule 100 as an extrinsic heating element. Heat may transfer to the food product 103 through the wall 102f of the receiving chamber 102c.

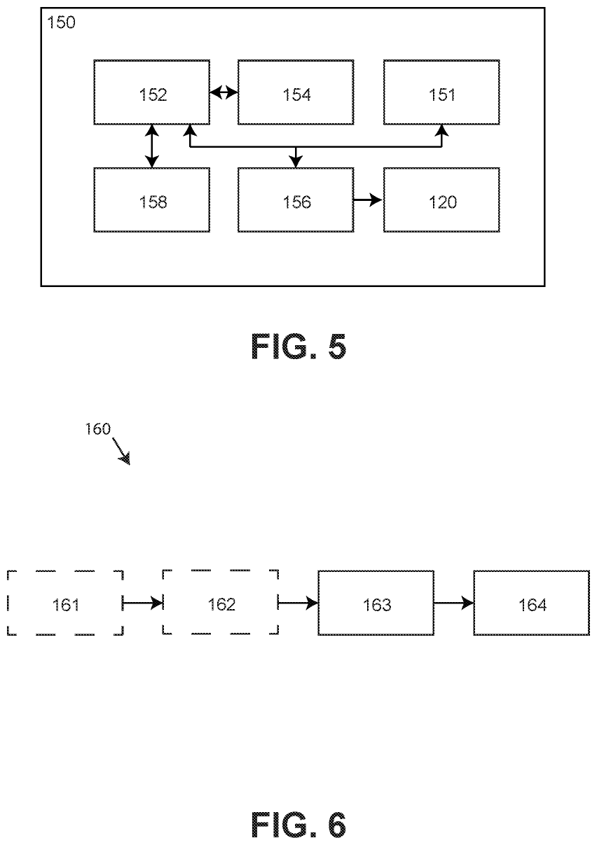

Referring now to FIGS. 1-6, FIG. 5 is a block diagram of an electronic control system (ECS) 150. The ECS 150 comprises the driveshaft 120, a processor 152, a memory 154, an actuator 156, one or more sensors 158, and one or more heating elements. In one embodiment, the one or more sensors 158 comprise one or more from the group consisting of: an RPM sensor, a proximity sensory, a temperature sensor, a current sensor, a force meter, and a photosensor. The actuator 156 refers to any electromechanical apparatus that can actuate the driveshaft 120, i.e., insert the driveshaft 120 into the central shaft 104d and subsequently rotate the blending component 104. Based on a given load, the actuator 156 is configured to apply a certain amount of torque. Other electronic control systems which effectively actuate the blending component 104 through the central opening 110a of the lid 110 may be contemplated by a person of ordinary skill in the art and are considered within the scope of the embodiments expressed herein.

Referring additionally to FIG. 6, in one embodiment, the memory 154 stores instructions executable by the processor 152 and which, when executed, cause the ECS 150 to perform a method 160 for utilizing a capsule 100 to blend a food product 103 therein and subsequently dispense the food product 103.

In one embodiment, the method 160 involves an optional step 161 of determining the capsule 100 is disposed in a predetermined position. The predetermined position ensures the blending component 104 is in alignment with and adequate proximity to the driveshaft 120. In one example, the capsule 100 may be disposed within a specified portion of a housing (not shown) of the ECS 150. A user may place the capsule 100 and the placement of the same may be determined by the one or more sensors 158 of the ECS 150.

Or, the user may place the capsule 100 in the predetermined position and trigger a ‘start’ button which may cause the ECS 150 to proceed without completing step 161.

In one embodiment, the ECS 150 then performs a step 163 of actuating the blending component 104 in a blending mode in which the blending component 104 is rotated by the driveshaft 120 in a direction such that the food product 103 is urged by the blending component 104 toward the lid 110.

In another embodiment, the ECS 150 performs a step 163 of actuating the blending component 104 in a blending mode in which the blending component 104 is rotated by the driveshaft 120 in a direction such that the food product 103 is urged by the blending component 104 toward the bottom opening 102b.

Among the ECS 150 functions is to measure the actual RPM of the driveshaft 120 during rotation (in any direction). Depending on the consistency of the food product 103 at the time of actuation, the actual RPM of the driveshaft 120 may vary widely. It will be generally accepted that an initial consistency of a frozen food product 103 will provide greater resistance to a rotational force than when the frozen food product 103 is warmed. As the blending component 104 is initially rotated, the rotational load on the blending component 104 is highest and as the food product 103 is blended, the friction between the blade 104c and the wall 102f of the receptacle 102c may generate heat which loosens the consistency of the food product 103. Once the consistency of the food product 103 loosens, the actual RPM of the driveshaft 120 increases (i.e., rotational torque decreases) and can be used by the processor to determine how close the food product 103 is to the desired consistency. In one embodiment, the actual RPM of the driveshaft 120 is compared to a target RPM by the processor 152. Reaching the target RPM indicates a desired consistency has been achieved. The target RPM may be a particular value, such as 1000 RPM, or may be a range of RPMs. The target RPM may vary based on the contents of the food product 103. The target RPM may be provided by the ECS manufacturer or the capsule manufacturer.

In another embodiment, step 163 involves determining whether the desired consistency is reached by measuring the external temperature of the receptacle 102. Based on a predetermined model, the internal temperature may be determined based on the external temperature. For example, the interior of the receptacle 102 may be approximately 2 degrees Celsius lower than the exterior, but the difference may differ based on the heat transfer coefficient of the contents of the food product 103, the material used for the receptacle 102, the dimension of the wall 102f, and other factors. Although temperature may be easy to measure and may be applicable to many situations where quality control before dispensing is desired, other metrics may be utilized to more precisely gauge the consistency of the blended food product 103, including, but not limited to: the RPM of the driveshaft 120, a draw of current by the electronic control system while blending the food product 103, a rotational torque applied to the blending component 104 by the driveshaft 120, and a downward force exerted onto the receptacle 102 by the rotation of the blending component 104.

When the target RPM has been reached, the ECS 150 performs a step 164 of actuating the blending component 104 in a dispensing mode in which the blending component 104 is rotated by the driveshaft 120 in an opposite direction to that of the blending mode such that the food product 103 is urged by the blending component 104 toward a bottom opening 102b of the capsule 100 and dispensed therethrough.

In an optional step 162 performed after step 161, the ECS 150 may recognize, through the one or more sensors, a food product label 102g adhered or imprinted onto the exterior of the receptacle 102. In one embodiment, the label 102g may comprise identification (ID) information of the food product 103 stored in the receptacle 102 and additionally, parameters which may modify the operation of the ECS 150. For example, the label 102g may comprise a threshold target associated with the food product 103 stored therein. Or the label 102g may comprise food ID information which may be used to look up a threshold target in a library of key-value pairs stored in the memory 154 and searchable by the processor 152. Upon reading the label 102g through, for example, an optical sensor of the ECS 150, the ECS 150 may use the information therein to adjust the threshold target. A threshold target may comprise one or more target values, such as, but not limited to, a target RPM of the driveshaft 120, a target current drawn by the electronic control system, a target rotational torque of the driveshaft 120, a target downward force applied to the receptacle 102, or a target internal temperature of the receptacle 102.

In another example, the label 102g may be a company logo or trademark which may be recognized by the processor 152 as a known brand. Based on the logo and/or other ID information, the ECS 150 may utilize corresponding configuration information stored in a library of the memory 154 to effect the operation of the ECS 150. In yet another example, the label 102g may comprise one or more RGB values, the corresponding data for which may be stored in a library of the memory 154 of the ECS 150.

In another example, the label 102g may comprise a predetermined temperature against which to compare the external temperature of the receptacle 102. In yet another example, the label 102g may comprise a duration of time to spend actuating the blending component 104. In another example, the label 102g may comprise a static or variable torque rating to apply through the actuator 156. The label 102g may comprise any of the above information in a human-readable form and/or a machine-readable form (e.g., barcode, QR code) and may be read by any of the one or more sensors 158. A machine-readable form may be preferred in order to automate the ECS 150 and reconfigure the ECS 150 as needed based on the capsule 100 used.

In another embodiment, the ECS 150 functions may be manually operable by a user, for example in a commercial or residential setting. A user may choose a capsule 100 from a plurality of capsules having different types of frozen food products stored therein, such as different flavors of ice cream. The ECS 150 may comprise one or more control interfaces 151 for initializing certain operations, such as buttons, dials, or sliders. In one embodiment, a driveshaft engagement button may be activated to cause the driveshaft 120 to engage with the blending component 104 after the user places the capsule in an appropriate position. In a further embodiment, a blend button may be activated to rotate the blending component 104 according to a blending mode in which the food product 103 is urged toward the lid 110. In yet a further embodiment, a dispense button may be activated to rotate the blending component 104 according to a dispensing mode in which the food product 103 is urged toward the bottom opening 102b. In yet another embodiment, a dial may be utilized to manually increase or decrease the amount of rotational torque applied by the driveshaft 120 and change the RPM of the blending component 104.

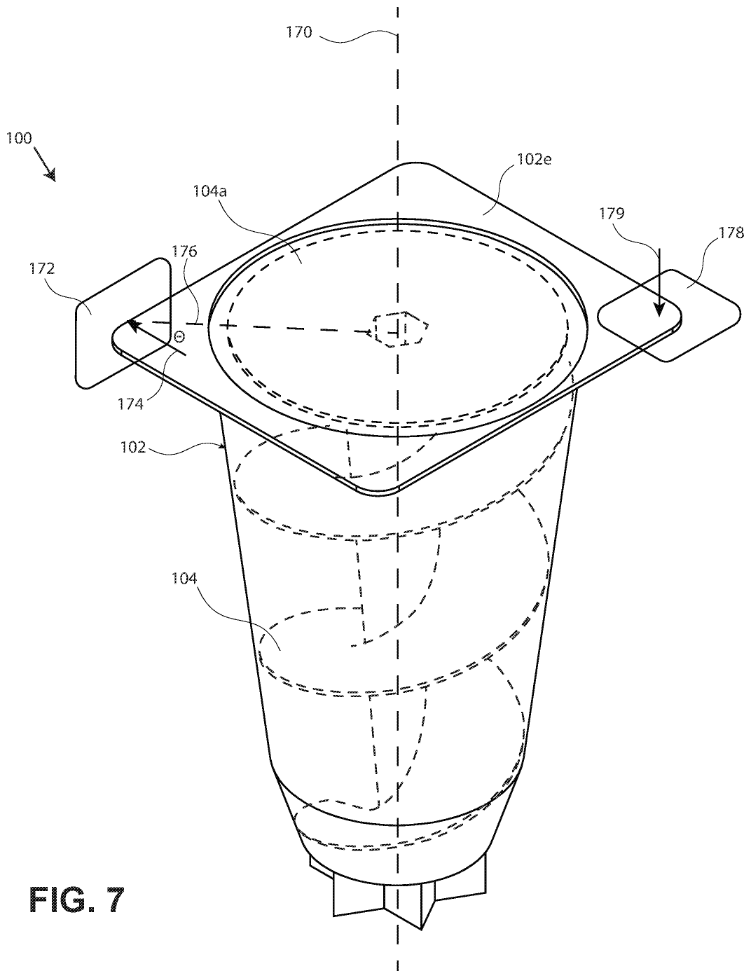

Referring to FIG. 7, a force diagram is shown. In one embodiment, the electronic control system may receive the capsule 100 within a chamber thereof (not shown). The chamber may comprise a groove which may accommodate, inter alia, the shape and thickness of the flange 102e of the receptacle 102. The electronic control system may additionally comprise force sensors 172 and 178 disposed within the groove. These force sensors may be utilized by the processor 152 to measure rotational and downward forces on the blending component 104 and/or the receptacle 102.

In one embodiment, rotational torque applied to the blending component 104, the food product 103 (not shown in FIG. 7), and subsequently to the receptacle 102 via the driveshaft around axis 170 may be measured by a force sensor disposed normal to the axis 170. For example, a force sensor 172 may be disposed normal to the flange 102e to measure a force 174. Rotational torque may be a product of a radius 176 (i.e., the horizontal distance from the point at which the force 174 is exerted and where the axis 170 meets the top end 104a), the applied force 174 and the sin of angle θ as shown. Other force sensors may be positioned similarly with respect to the axis 170 to measure rotational torque applied to the receptacle 102.

Rotational torque may be one of numerous metrics which can be used to intuit the consistency of the capsule contents in real-time. In a preferred embodiment, a certain amount of torque may be applied to achieve a desired RPM of the blending component 104 and effectively push the capsule's contents away from the central axis 170 via centrifugal force. During operation, a minimum centrifugal force may be needed to repel the capsule's contents away from the central axis of the blending component 104. This centrifugal force may be achieved at a range of RPM, such as approximately 1000 to 1500 RPM. Depending on the initial hardness of the capsule contents and the ingredients therein, a rotational torque range of approximately 5 to 15 Nm may be suitable.

In another embodiment, a force sensor 178 may be disposed coplanar with and below the flange 102e to measure a downward force 179 exerted on the receptacle 102 applied by the food product 103, which is urged toward the bottom of the receptacle 102 when the blending component 104 is rotated. This downward force 179 may also be used to intuit the consistency of the food product 103. While the food product 103 is substantially solid, the exerted downward force 179 may be higher than when the food product 103 consistency loosens.

In another embodiment, the electronic control system may measure current during operation. Current may directly correlate to the rotational torque applied to the capsule via the driveshaft and may be monitored to gauge the consistency of the blended product. Along with actual force measurement via the force sensor 172, current may be utilized by the electronic control system to determine an optimal operation time for the contents of the capsule. Utilizing the above measurements to provide feedback to the electronic control system during blending, the operation of the electronic control system may be agnostic of the environmental conditions thereof or the contents of the capsule.

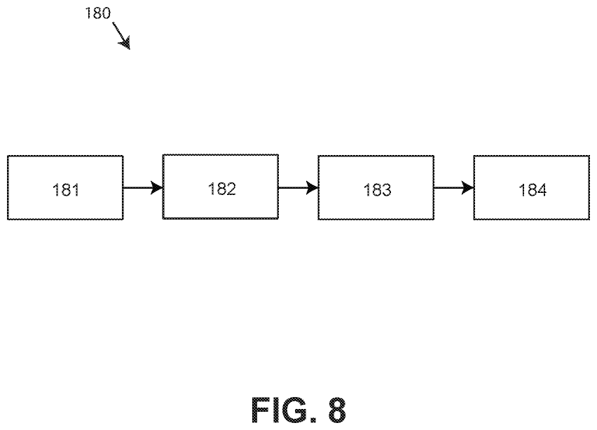

Referring to FIG. 8, a method 180 for dispensing a blended food product contained in a capsule is shown. In a step 181, a method of dispensing a food product through a receptacle of a capsule as described in the embodiments herein involves applying a target rotational torque to a blending component situated within the receptacle. The rotation of the blending component causes the food product to travel through a passageway created by the helical blade of the auger-like blending component against the walls of the receptacle, toward a tip portion of the blending component, and up against a removable seal covering a bottom opening of the receptacle. The food product may gradually blend as it eddies within the receptacle and the against the walls of the same.

To achieve a desired consistency, blending preferably involve rotating the blending component at approximately 1000 to 1500 RPM, applying a rotational torque to the blending component of approximately 5 to 15 Nm, and/or applying a threshold current to a driveshaft motor rotating the blending component. The threshold current may vary based on motor rating, power supply, and other components. Generally, the threshold current is a minimum current necessary to achieve the above RPM or torque rating.

The 1000 to 1500 RPM range was found to reliably exert a centrifugal force on the food product and effectively push the food product away from a central axis extending vertically through the helical blade of the blending component. Food product which stays lined against the central shaft of the blending component may harden prematurely and prevent a homogenous mixture from forming. As such, the centrifugal force is a necessary component of the blending process. A rotational torque applied to the food product must sufficiently break through the typically solid initial consistency of the food product. Although the contents of different varieties of food products may differ, a rotational torque of 5 to 15 Nm was sufficient to reliably blend a desired soft serve consistency. These metrics, which are intrinsic to the physical components of the system, may be directly correlated with a current drawn by the electronic control system, which serves as an extrinsic measure of consistency and which can be relied upon in place of or in combination with the above measurements.

In a step 182, the method additionally involves determining whether a threshold target value has been met. A threshold target may comprise one or more target values, such as, but not limited to, a target RPM of the driveshaft 120, a target current drawn by the electronic control system, a target rotational torque of the driveshaft 120 (i.e., measured by force sensor 172), a target downward force applied to the receptacle 102 (i.e., measured by force sensor 178), or a target internal temperature of the receptacle 102. The one or more target values may be derived by scanning a label 102g of the receptacle. The label 102g may reference a key-value pair stored in a memory of an electronic control system or a memory of a networked data processing device.

In a preferred embodiment, the method involves determining whether a threshold rotational torque is applied to the blending component by measuring a current drawn by the electronic control system during blending and comparing the current to a target current value associated with a rotational torque known to yield a desired consistency for the food product stored within the capsule. For example, an effective rotational torque value range for achieving a desired consistency may be around 5 to 15 Nm.

In a step 183, upon determining that the threshold value is met, the electronic control system may stop blending and provide a prompt to remove the seal from the bottom opening of the receptacle and receive a confirmation to proceed. The confirmation may be provided by a user through an input interface of the electronic control system (e.g., “Dispense” button).

Alternately, in step 183, a downward force exerted on the capsule 100 may be measured to determine whether the removable seal 114 has been removed. When the seal is in place, downward pressure from rotating food product may exert a downward force on the removable seal 114, which may in turn pull on the receptacle 102, to the extent that the adhesion between the removable seal and the receptacle can withstand. The system may be pre-programmed to prevent the measured downward force from exceeding a known value which can cause the removable seal to snap inadvertently and food product to dispense prematurely.

The system may also be pre-programmed to detect whether the food product is dispensing when the blending component 104 rotates, i.e., whether the removable seal 114 has been removed. This may be detected, for example, if the downward force on the receptacle 102 no longer changes significantly as the load on the blending component 104 is increased or decreased. This is the case because pressure does not build within the receptacle 102 after the receptacle 102 is unsealed. However, in most cases, removal of the removable seal 114 may not be reliably observable through the use of force sensors. Rather, in one embodiment, the electronic control system may comprise an infrared emitter and sensor positioned toward the removable seal 114. The emitter/sensor combo may allow the electronic control system to detect the presence of objects in the line of sight of the emitter/sensor. A removable seal may be easily recognizable as a non-moving, typically reflective, static surface. Thus, the emitter/sensor can be utilized to enable an additional way for the electronic control system to automate the dispensing method 180.

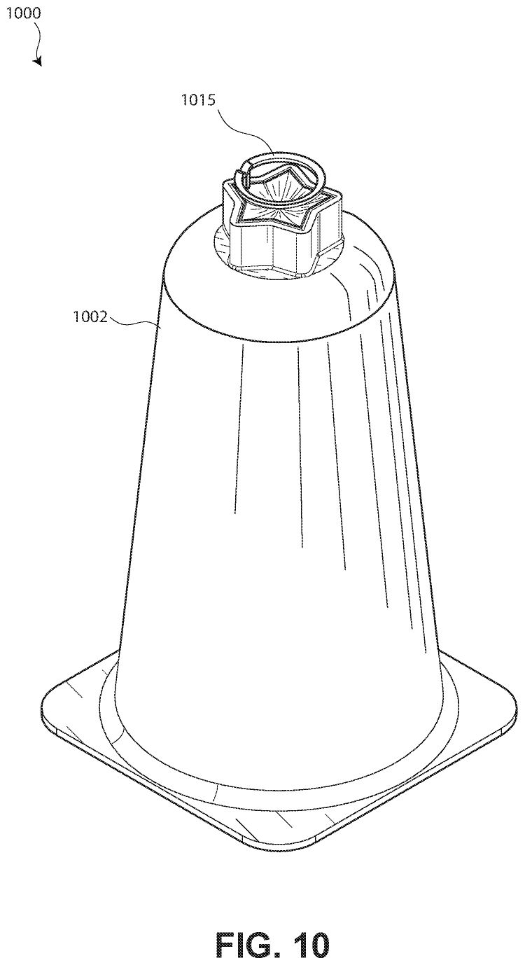

Alternately, in step 183, the electronic control system may remove the removable seal 114 automatically. For example, as shown in FIG. 10, the capsule 1000 may comprise a removable seal 114 with ring handle 1015. The ring handle 1015 may be mechanically removed and disposed in a removal bin by, e.g., a hooking action pulling the ring away from the receptacle 1002. In a non-mechanical embodiment, a user may manually remove the seal via the ring handle 1015.

In a step 184, upon receiving confirmation, the method involves applying a predetermined rotational torque to the blending component 104 and dispensing the food product 103 at the desired consistency through the bottom opening of the receptacle 102.

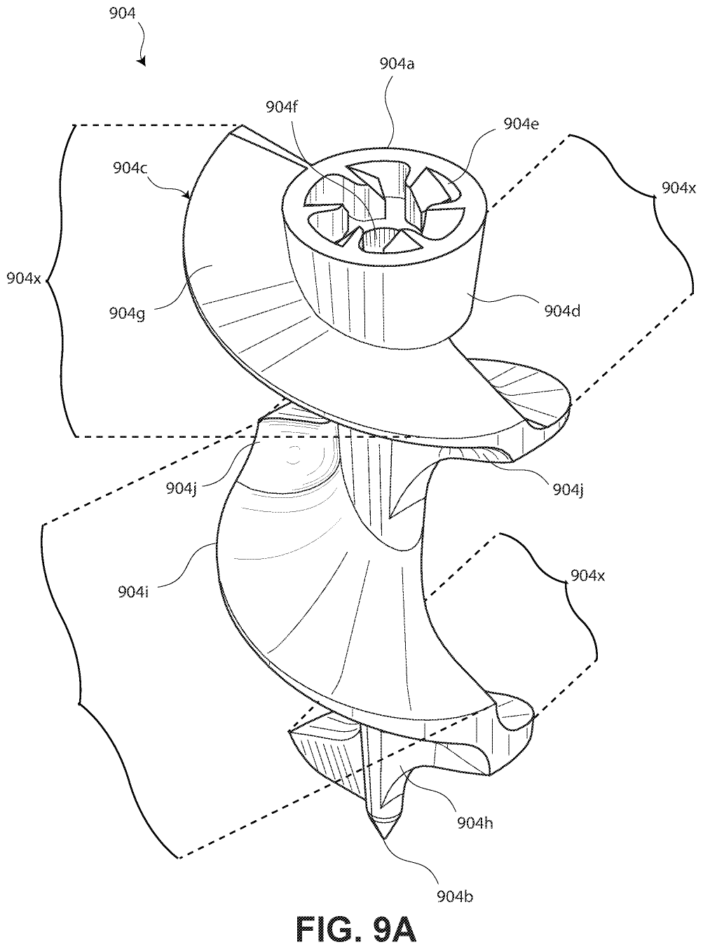

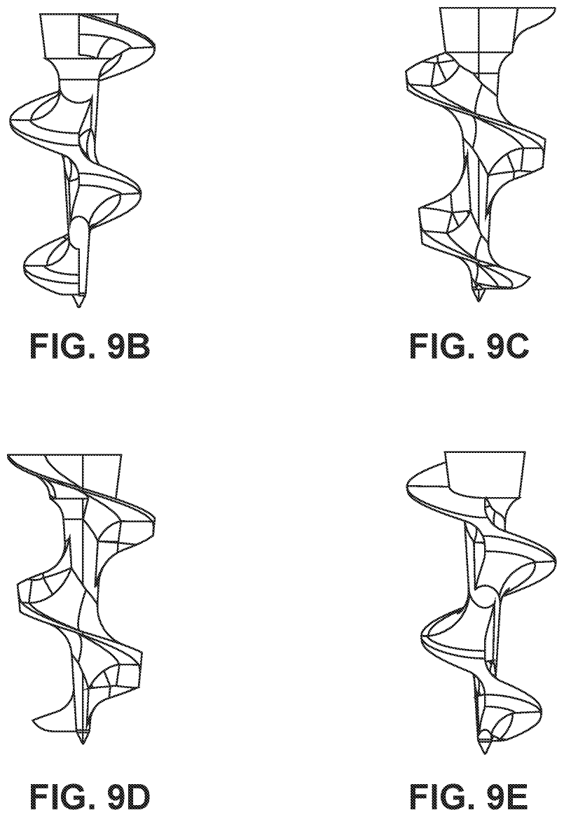

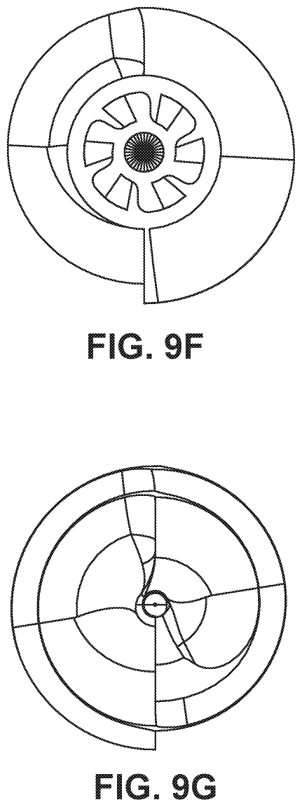

Referring to FIG. 9, a perspective view of a stepped blending component is shown. FIGS. 9B-G are plan views thereof. As shown in FIG. 9, the helical blade 904c of blending component 904 may comprise one or more stepped portions 904j. In another embodiment, only one of the two surfaces may be stepped, i.e., the un-stepped surface may be linear like the rest of the portions of the surface.

The stepped portion 904j may comprise a concave surface and effectively separates the helical blade 904c into multiple steps. The curvature of the stepped portion 904j may allow the blending component 904 to exert forces more directly to the food product. Otherwise, the helical blade 904c maintains a regular slope along the top surface 904g and the bottom surface 904h. The stepped portion 904j may aid in blending the food product by providing a scooping action. In other words, the stepped portion 904j may scoop and agitate the food product as the blending component 904 is rotated in the direction the stepped portion 904j is oriented.

In addition to aiding blending, the stepped portion 904j may aid in manufacturing in injection molding environments by making it easier to eject the blending component 104 after formation within the mold. Additionally, the stepped portion 904j may add rigidity to the structure. In a further embodiment, the outer edge 904i may be chamfered to add further rigidity.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

1. (canceled)

2. (canceled)

3. (canceled)

4. (canceled)

5. (canceled)

6. (canceled)

7. (canceled)

8. (canceled)

9. (canceled)

10. A method of blending and dispensing a food product stored in a capsule, comprising:
actuating, through a driveshaft of an electronic control system, a blending component disposed within a receiving chamber of a receptacle of the capsule,
wherein the receptacle comprises a top opening and a bottom opening,
wherein the bottom opening is hermetically sealed by a removable seal and the receiving chamber is surrounded by a wall of the receptacle,
wherein the receiving chamber is adapted to receive and store a food product therein,
wherein the receptacle further comprises a lid having a central opening,
wherein the blending component is embedded with the food product and comprises a top end having an aperture accessible through the central opening;
wherein actuating the blending component involves blending the food product to a soft serve consistency,
wherein the blending component further comprises an auger-like blade having a first surface and a second surface joined by an edge which extends laterally from a central axis of the blending component and sits flush against the wall of the receptacle,
wherein the auger-like blade helically spans from the top end to a tip portion around the central axis,
wherein the auger-like blade is split into a plurality of steps;
wherein the first surface and the second surface comprise a concave portion between each of the steps;
wherein blending involves rotating the blending component via the driveshaft and thereby applying a rotational torque to the food product, causing one of the first surface, the second surface, and the concave portion to move the food product around and along the central axis,
wherein rotating the blending component causes the helical auger-like blade to move the food product outward from the central axis and urge the food product to eddy against the wall of the receptacle;
wherein actuating the blending component further involves dispensing the food product through the bottom opening.

11. The method of claim 10, wherein rotating the blending component causes the concave portions of at least one of the first surface and second surface to scoop the food product in the direction the blending component is rotated.

12. The method of claim 10, wherein dispensing the food product additionally involves prompting to remove the removable seal from the bottom opening of the receptacle.

13. The method of claim 10, wherein dispensing the food product additionally involves mechanically removing the removable seal from the bottom opening of the receptacle via the electronic control system.

14. The method of claim 10, wherein ending the step of blending the food product additionally involves detecting whether a threshold value has been met by the electronic control system.

15. The method of claim 14, wherein the threshold value is an RPM value and is approximately 1000 to 1500 RPM.

16. The method of claim 14, wherein the threshold value is a rotational torque applied to the food product and is approximately 5 to 15 Nm.

17. The method of claim 14, wherein the threshold value is a current drawn by the electronic control system which is closely associated with the desired consistency.
